(19) United States
(12) Patent Application Publication
(10) Pub. No.: US 2025/0240293 A1
(43) Pub. Date: Jul. 24, 2025

(54) MULTI-TENANT SECRETS MANAGER

(71) Applicant: Dell Products L.P., Round Rock, TX (US)

(72) Inventors: Viswanath Ponnuru, Bangalore (IN); Vinay Sawal, Fremont, CA (US); Sumanth Vidyadhara, Bangalore (IN); Judith A. Furlong, Natick, MA (US)

(21) Appl. No.: 18/417,341

(22) Filed: Jan. 19, 2024

(51) Int. Cl. H04L 9/40

(52) U.S. Cl. CPC H04L 63/10; H04L 63/08

(57) ABSTRACT

One example method includes receiving, by a confidential container service from a tenant, a request to provision a tenant node, provisioning the tenant node using a multi-tenant trusted execution environment (TEE) attested resource provisioning process, receiving, from the tenant, tenant-specific security information concerning the tenant node, storing the tenant-specific security information in a tenant-specific catalog, implementing security procedures, specified in the tenant-specific security information, in the tenant node, and upon successful authentication of the tenant, using the security procedures, enabling the tenant to access the tenant specific confidential resources from the tenant node(s).

### FIELD OF THE INVENTION

Embodiments of the present invention generally relate to operations in a containerized workload environment. More particularly, at least some embodiments of the invention relate to systems, hardware, software, computer-readable media, and methods, for management of tenant secrets in a containerized workload management environment.

### BACKGROUND

Security concerns remain a significant challenge for adopting and running containerized applications in Kubernetes. The State of Kubernetes Security Report, produced by Red Hat, analyzed survey data from over 500 IT and security decision-makers, indicated a significant trend. Specifically, the report revealed that 59% of respondents are most concerned with unaddressed security and compliance needs or threats to containers. This is particularly concerning in containerized workload environments that may have many tenants.

Poor secret management can lead to detrimental consequences, leaving companies susceptible to security breaches of all kinds. To make matters worse, one secret may, in some circumstances, be used to unlock resources that contain even more secrets.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses a hypothetical comparative example to illustrate a circumstance that may be addressed by an embodiment.

FIG. 2 discloses aspects of an architecture according to an embodiment.

FIG. 3 discloses a method according to an embodiment.

FIG. 4 discloses a computing entity configured and operable to perform any of the disclosed methods, processes, and operations.

### DETAILED DESCRIPTION OF SOME EXAMPLE EMBODIMENTS

Embodiments of the present invention generally relate to operations in a containerized workload environment. More particularly, at least some embodiments of the invention relate to systems, hardware, software, computer-readable media, and methods, for management of tenant secrets in a containerized workload management environment.

One example embodiment comprises a method which may be performed in whole, or in part, by a multi-tenant secrets manager using a confidential container microservice. In an embodiment, the method may be performed in a containerized workload management environment, such as Kubernetes for example.

In an embodiment, the method may comprise the following operations: receiving a tenant request to access confidential services for use in provisioning services of the tenant; provisioning the identified tenant services; receiving, from the tenant, catalog information that may include, for example, tenant id, metadata, compute devices information, service tags, and security certificates; creating a tenant-specific catalog to store the catalog information; enabling the tenant to plugin to a cloud framework identified by the tenant; providing a secrets management service to the tenant with respect to a node, or nodes, identified by the tenant, so as to enable the tenant to construct, or request the construction of, a trusted execution environment; permitting access to the trusted execution environment, in accordance with information specified in the catalog; and, running a workload of the tenant in the trusted execution environment.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that a tenant need not rely on a workload management environment to manage security for the tenant. In an embodiment, a tenant may set up its own, customized, security for its containers in a workload management environment. Various other advantages of one or more example embodiments will be apparent from this disclosure.

### A. Context for an Example Embodiment

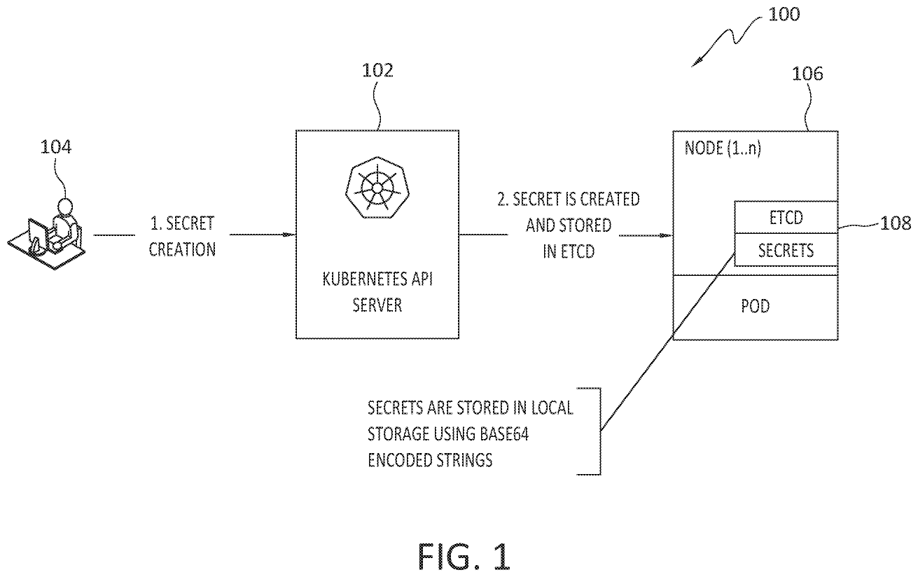

With particular attention to FIG. 1, one example of an operating environment for embodiments of the invention is denoted generally at 100. This hypothetical example illustrates some potential concerns to which one or more embodiments may be directed.

The example environment 100, which may comprise a containerized workload management environment, may comprise a Kubernetes API (application program interface) server 102, configured to communicate with a tenant 104, and with one or more tenant nodes 106. In the case of Kubernetes, for example, each of the tenant nodes 106 may comprise an ‘etcd’ secrets store 108 in local storage. In operation, the tenant 104 may (1) create a secret which is then received the Kubernetes API server 102, and stored (2) in the secrets store 108. The tenant secret may be stored using, for example, base64 encoded strings generated by the Kubernetes API server 102. That is, Kubernetes stores sensitive data, such as the tenant secret, using the Secret object that is simply base64 encoded strings. As a result, anyone with API access, that is, access to the Kubernetes API server 102, can retrieve or modify a Secret. Moreover, by enabling the Kubernetes platform to encode the secret, the tenant has given up a measure of control over the security of its node(s).

### B. Aspects of an Example Architecture

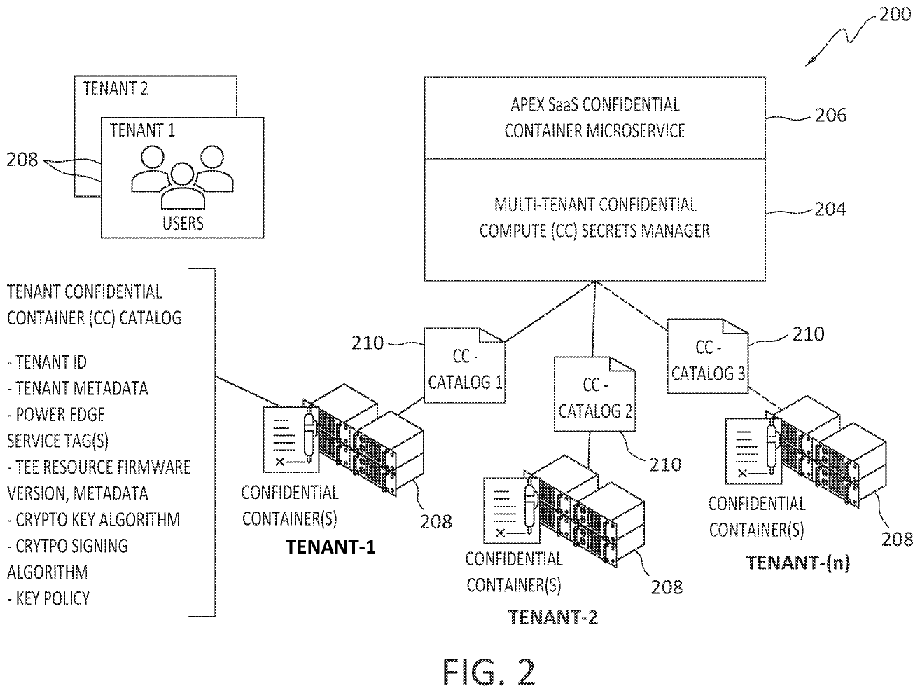

Protecting data in the cloud continues to gain importance and is challenging for both consumers, or tenants, and the cloud service provider. Thus, one example embodiment comprises an architecture 200 as disclosed in FIG. 2. In an embodiment, the architecture 200 may comprise a Dell APEX architecture and environment, and associated entities, but that is not required.

As shown in FIG. 2, the architecture 200 may comprise a multi-tenant confidential compute (CC) secrets manager, or ‘secrets manager,’ 204 running a confidential container microservice (CCM) 206. The CCM 206 may be made available to one or more tenants 208. The secrets manager 204 may generate a respective, tenant-specific, CC catalogue 210 for each of the tenants 208. Information, such as security information, included in the CC catalogues 210 may be provided by the respective tenants 208. In general, such information, some, or all, of which may be tenant-specific, may comprise materials that the tenant 208 has deemed necessary to ensure the security of its nodes, or containers, in the architecture 200. For example, such information may include, but is not limited to, tenant id, tenant metadata, Dell PowerEdge service tags, TEE (trusted execution environment) resource firmware version and metadata, crypto key algorithms, crypto signing algorithms, and key policies. With this security information, a tenant 208 may be able to set up its own security parameters to control access to its containers and other information. Moreover, the use of a catalogs 210 may enable the tenant 208 to change or update its security requirements and policies at any time, and possibly automatically, such as after a specified time interval has passed, for example.

Thus, an embodiment may comprise a cloud managed confidential containerized method to shield tenant clusters against security attack vectors and to ensure that only an authorized tenant has access to the tenant confidential data and TEE resource lifecycle. In more detail, one particular embodiment may comprise a cloud-managed, such as by Dell APEX for example, tenant-specific confidential resource catalog which contains the tenant cluster configuration details such as, TEE resource discovery, provisioning and subscription licenses and resource shared policies, for multiple tenants or private use, for security isolations, crypto algorithms and crypto key policies. Another embodiment may comprise simplified, possibly Dell APEX, cloud tenant confidential cluster secrets management of TEE resources, such as security update, configurations updates, crypto key management policies, by way of controlled, possibly by Dell APEX, configuration update management.

### C. Example Methods

It is noted with respect to the disclosed methods that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

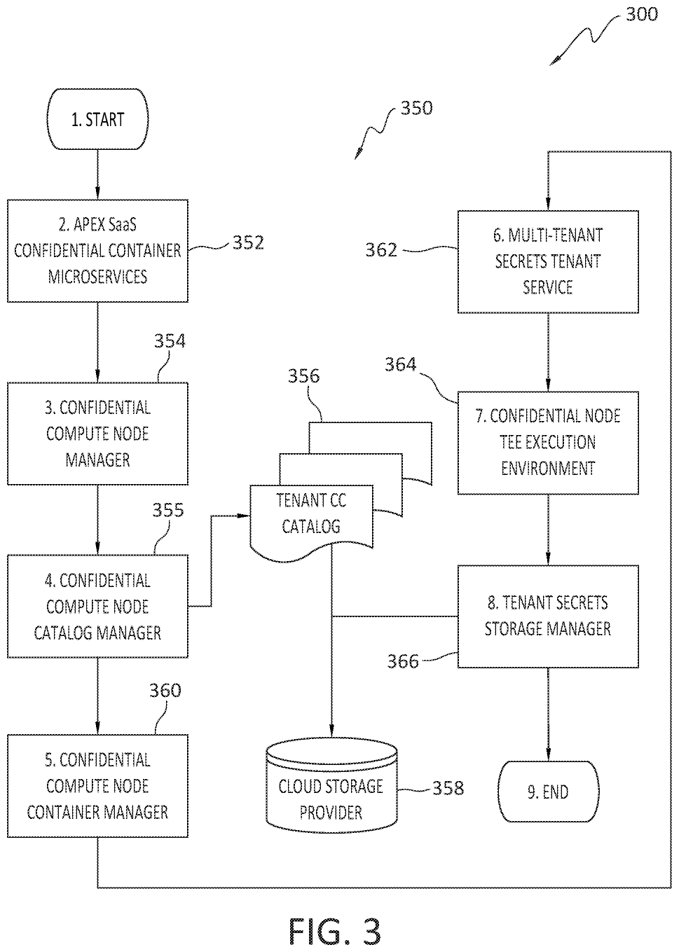

Directing attention now to FIG. 3, aspects of an example method 300, and an associated group of entities 350, are disclosed. In an embodiment, the group of entities 350 may collectively define and implement a multi-tenant secrets manager. In general, the example method 300 comprises end-to-end message flows that enable the secure secrets manager capabilities for a multi-tenant architecture using confidential cloud container technologies.

The example method 300, any part(s), or all, of which may be provided as-a-Service (aaS) to one or more tenants, may begin when a tenant logs into (1) a cloud infrastructure management self-service portal, such as a Dell APEX portal for example. The tenant may then leverage (2) SaaS confidential container services 352, such as those provided by Dell APEX for example, for provisioning the tenant services. A CC node manager 354 may then implement (3) resource provisioning using a multi-tenant TEE attested resource provisioning method.

A CC node catalog manager 355 may, for example, provide (4) tenant services to store and manage tenant catalog 356 information that may include tenant id, metadata, PowerEdge compute devices, service tags and security certificates, for example. The tenant catalog(s) 356 may be stored in a cloud storage provider database 358, accessible by the tenant(s), for configuration management purposes, and/or other purposes.

Next, a confidential compute node container manager 360 may provide (5) cloud management service plugins to various cloud frameworks, such as cloud frameworks implemented in public clouds. Such cloud frameworks, or cloud infrastructures, may comprise frameworks for managing containerized workloads executed in a cloud environment, and may comprise frameworks such as Kubernetes, and Docker, for example.

A multi-tenant secrets tenant service, or manager, 362 may provide (6) tenant secrets management services to one or more tenants. The tenant secrets management services may be implemented as provided by tenant-specific confidential compute technology guidelines, possibly stored in the tenant catalog 356, on/for the specific confidential tenant nodes.

Next, the tenant secrets manager 363 may use (7), possibly in connection with the execution of a tenant workload, a confidential tenant node TEE 364 for processing and computing sensitive information/data in a TCB (trusted computing base). A tenant secrets storage manager 366 may store (8), such as in the cloud storage provider database 358, tenant secrets cipher information may be stored in an external, that is, public, cloud storage environment. Finally, this instance of the example method 300 may terminate (9).

### D. Further Discussion

As apparent from this disclosure, an embodiment may possess various useful features and aspects, although no embodiment is required to possess any of such features or aspects. The following examples are illustrative. An embodiment may comprise a cloud-managed, tenant-specific, confidential resource catalog which contains the tenant cluster configuration details such as, for example, TEE resource discovery, provisioning and subscription licenses and resource shared policies, for multiple tenants or private use, for security isolations, crypto algorithms, and crypto key policies. As another example, and embodiment may comprise cloud tenant confidential cluster secrets management of TEE resources, such as security update, configurations updates, crypto key management policies, by way of controlled configuration update management. Thus, an embodiment may provide seamless security trust, and OEM (original equipment manufacturer) certified node configuration management.

### E. Further Example Embodiments

Following are some further example embodiments of the invention. These are presented only by way of example and are not intended to limit the scope of the invention in any way.

### Embodiment 1

A method, comprising: receiving, by a confidential container service from a tenant, a request to provision a tenant node; provisioning the tenant node using a multi-tenant trusted execution environment (TEE) attested resource provisioning process; receiving, from the tenant, tenant-specific security information concerning the tenant node; storing the tenant-specific security information in a tenant-specific catalog; implementing security procedures, specified in the tenant-specific security information, in the tenant node; and upon successful authentication of the tenant, using the security procedures, enabling the tenant to access tenant specific confidential resources from the tenant node.

### Embodiment 2

The method as recited in any preceding embodiment, further comprising receiving, from the tenant, a change to the tenant-specific security information.

### Embodiment 3

The method as recited in embodiment 2, further comprising updating the tenant-specific catalog with the change.

### Embodiment 4

The method as recited in any preceding embodiment, wherein a cloud management service plugin to a cloud framework is provided to the tenant by a confidential compute node container manager.

### Embodiment 5

The method as recited in any preceding embodiment, wherein the tenant-specific security information comprises any one or more of: tenant id; tenant metadata; tenant service tag; or tenant security certificate.

### Embodiment 6

The method as recited in any preceding embodiment, wherein the tenant-specific catalog is stored at a cloud site that includes the tenant node.

### Embodiment 7

The method as recited in any preceding embodiment, wherein the tenant-specific catalog is provided by a confidential compute node catalog manager.

### Embodiment 8

The method as recited in any preceding embodiment, wherein the provisioning, the storing, and the implementing, are all provided as-as-Service to the tenant.

### Embodiment 9

The method as recited in any preceding embodiment, wherein when the tenant is authenticated, running a tenant workload on the tenant node.

### Embodiment 10

The method as recited in embodiment 9, wherein the tenant workload is a containerized workload implemented using a containerized workload management system.

### Embodiment 11

A system, comprising hardware and/or software, operable to perform any of the operations, methods, or processes, or any portion of any of these, disclosed herein.

### Embodiment 12

A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments, which may be remote or on-prem, where one or more of a client, server, or other machine may reside and operate in a cloud environment.

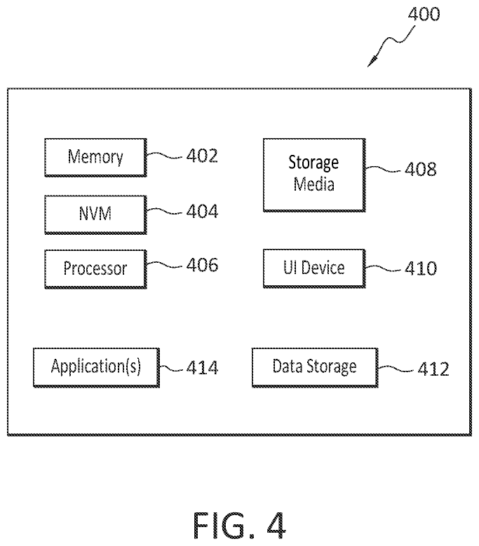

With reference briefly now to FIG. 4, any one or more of the entities disclosed, or implied, by FIGS. 1-3, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving, by a confidential container service from a tenant, a request to provision a tenant node;
provisioning the tenant node using a multi-tenant trusted execution environment (TEE) attested resource provisioning process;
receiving, from the tenant, tenant-specific security information concerning the tenant node;
storing the tenant-specific security information in a tenant-specific catalog;
implementing security procedures, specified in the tenant-specific security information, in the tenant node; and
upon successful authentication of the tenant, using the security procedures, enabling the tenant to access tenant specific confidential resources from the tenant node.

2. The method as recited in claim 1, further comprising receiving, from the tenant, a change to the tenant-specific security information.

3. The method as recited in claim 2, further comprising updating the tenant-specific catalog with the change.

4. The method as recited in claim 1, wherein a cloud management service plugin to a cloud framework is provided to the tenant by a confidential compute node container manager.

5. The method as recited in claim 1, wherein the tenant-specific security information comprises any one or more of: tenant id; tenant metadata; tenant service tag; or tenant security certificate.

6. The method as recited in claim 1, wherein the tenant-specific catalog is stored at a cloud site that includes the tenant node.

7. The method as recited in claim 1, wherein the tenant-specific catalog is provided by a confidential compute node catalog manager.

8. The method as recited in claim 1, wherein the provisioning, the storing, and the implementing, are all provided as-as-Service to the tenant.

9. The method as recited in claim 1, wherein when the tenant is authenticated, running a tenant workload on the tenant node.

10. The method as recited in claim 9, wherein the tenant workload is a containerized workload implemented using a containerized workload management system.

11. A non-transitory storage medium having stored therein instructions that are executable by one or more hardware processors to perform operations comprising:
receiving, by a confidential container service from a tenant, a request to provision a tenant node;
provisioning the tenant node using a multi-tenant trusted execution environment (TEE) attested resource provisioning process;
receiving, from the tenant, tenant-specific security information concerning the tenant node;
storing the tenant-specific security information in a tenant-specific catalog;
implementing security procedures, specified in the tenant-specific security information, in the tenant node; and
upon successful authentication of the tenant, using the security procedures, enabling the tenant to access the tenant node.

12. The non-transitory storage medium as recited in claim 11, further comprising receiving, from the tenant, a change to the tenant-specific security information.

13. The non-transitory storage medium as recited in claim 12, further comprising updating the tenant-specific catalog with the change.

14. The non-transitory storage medium as recited in claim 11, wherein a cloud management service plugin to a cloud framework is provided to the tenant by a confidential compute node container manager.

15. The non-transitory storage medium as recited in claim 11, wherein the tenant-specific security information comprises any one or more of: tenant id; tenant metadata; tenant service tag; or tenant security certificate.

16. The non-transitory storage medium as recited in claim 11, wherein the tenant-specific catalog is stored at a cloud site that includes the tenant node.

17. The non-transitory storage medium as recited in claim 11, wherein the tenant-specific catalog is provided by a confidential compute node catalog manager.

18. The non-transitory storage medium as recited in claim 11, wherein the provisioning, the storing, and the implementing, are all provided as-as-Service to the tenant.

19. The non-transitory storage medium as recited in claim 11, wherein when the tenant is authenticated, running a tenant workload on the tenant node.

20. The non-transitory storage medium as recited in claim 19, wherein the tenant workload is a containerized workload implemented using a containerized workload management system.
